(19) United States
(12) Patent Application Publication
(10) Pub. No.: US 2009/0178315 A1
(43) Pub. Date: Jul. 16, 2009

(54) WHEEL DEVICE, BLANK, AND METHOD OF MAKING DEVICE

(76) Inventor: Richard A. BURTCH, Aurora (CA)

Correspondence Address: STITES & HARBISON PLLC, 1199 NORTH FAIRFAX STREET, SUITE 900, ALEXANDRIA, VA, 22314, US

(21) Appl. No.: 12/013,068

(22) Filed: Jan. 11, 2008

(51) Int. Cl. G09F 9/37

(52) U.S. Cl. 40/446

(57) ABSTRACT

A wheel display device having a wheel panel including an inner wheel hub portion, a wheel portion releasably secured to and circumscribing the hub portion, a tab portion releasably secured to the wheel portion, and at least one wheel support arch portion releasably connected to the wheel portion and to the tab portion; a first sheath panel connected to the wheel panel and joined to at least one arch portion along a fold line to permit the wheel portion to be folded over onto the first panel; and a second sheath panel joined to the first panel along a fold line to permit the second panel to be folded over onto the first panel to capture the wheel panel therebetween. When the tab portion is removed, the wheel portion can be released from the hub portion and at least one arch portion to rotate about the hub portion.

### BACKGROUND OF THE INVENTION

1. Field of the Invention

The present invention generally relates to advertising and other information-presenting devices, and, more specifically, to a wheel device formed from a single blank, and to a method of assembling the display device.

2. Description of Prior Art

A wheel chart or wheel device is a simple mechanical device that enables a user to rotate a wheel contained within the device to obtain different information depending on the rotational position of the wheel relative to a window or other opening in the device through which the information carried by the wheel can be viewed. Such a wheel device can be used in advertising, i.e., advertisers can employ the wheel device to advertise and market their products and services. Also, the wheel device can present advertising material and other information interactively, i.e., different information can be presented as the wheel is rotated by the user, thereby making the advertising material more effective. However, in order to be a commercially viable information source, particularly in mass marketing applications, such a wheel device must be able to be made cheaply. Current wheel devices that are used to present various kinds of different information typically use multiple pieces that must be joined together, and employ separate metal rivots or the like in mounting the wheel for rotation.

### SUMMARY OF THE INVENTION

In accordance with the invention, there are provided a wheel display device, a blank, and a method for assembling the blank, which afford important advantages over the prior art. The blank and the device made from the blank are simple and inexpensive to make. The device allows for interactivity and because of its low cost can be an inexpensive yet effective advertisement tool.

In accordance with the invention, a blank for a wheel display device includes a wheel panel. The wheel panel has an inner wheel hub portion, a wheel releasably secured to and circumscribing the inner wheel hub portion, a removeable tab portion releasably secured to the wheel portion, and at least one wheel support arch portion releasably connected to the wheel portion and to the tab portion. A first sheath panel is connected to the wheel panel and joined to the at least one wheel support arch portion along a first fold line so as to permit the wheel portion to be folded over onto the first sheath panel. A second sheath panel is joined to the first sheath panel along a second fold line so as to permit the second sheath panel to be folded over onto the first sheath panel so as to capture the wheel panel therebetween. The first sheath panel includes a first indentation therein in an edge thereof adjacent to the tab portion and the second sheath panel includes a second indentation that registers with the first indentation when the sheath panel is folded over onto the first sheath panel so as to permit access to the wheel portion when the tab portion is removed such as to permit the wheel portion to be released from the inner wheel hub portion and at least one wheel support arch portion and to rotate about the inner wheel hub portion.

Advantageously, the first sheath panel defines at least one cutout window. Advantageously, the second sheath panel defines at least one cutout window. Advantageously, the blank includes a third panel joined to the first sheath panel along a third fold line. Advantageously, third panel includes a third indentation therein in an edge thereof that registers with the first and second indentations. Advantageously, the blank includes a fourth panel joined to the third panel along a fourth fold line.

In accordance with the invention, the method for assembling a wheel display device from a blank includes the steps of providing the planar blank. The blank for a wheel display device includes a wheel panel. The wheel panel has an inner wheel hub portion, a wheel releasably secured to and circumscribing the inner wheel hub portion, a removeable tab portion releasably secured to the wheel portion, and at least one wheel support arch portion releasably connected to the wheel portion and to the tab portion. A first sheath panel is connected to the wheel panel and joined to the at least one wheel support arch portion along a first fold line so as to permit the wheel portion to be folded over onto the first sheath panel. A second sheath panel is joined to the first sheath panel along a second fold line so as to permit the second sheath panel to be folded over onto the first sheath panel so as to capture the wheel panel therebetween. The first sheath panel includes a first indentation therein in an edge thereof adjacent to the tab portion and the second sheath panel includes a second indentation that registers with the first indentation when the sheath panel is folded over onto the first sheath panel so as to permit access to the wheel portion when the tab portion is removed such as to permit the wheel portion to be released from the inner wheel hub portion and at least one wheel support arch portion and to rotate about the inner wheel hub portion. The second step includes placing a first adhesive deposit on a first surface of the inner wheel hub portion. The next step includes folding the wheel panel along the first fold line over onto the first sheath panel, such that the first surface of the inner wheel hub portion adheres to the first sheath panel by the first adhesive deposit. The next step includes placing a second adhesive deposit on a second surface of the inner wheel hub portion. The last step includes folding the second sheath panel along the second fold line, such that the second sheath panel adheres to the second surface of the inner wheel hub portion by the second adhesive deposit.

Preferably, prior to the step of folding the wheel panel along the first fold line, the method further includes the step of placing a third adhesive deposit on a first surface of at least one wheel support arch portion, such that upon folding the wheel panel along the first fold line, the first surface of at least one wheel support arch portion adheres to the first sheath panel by the third adhesive deposit.

Preferably, prior to the step of folding the second sheath panel along the second fold line, the method further includes the step of placing a fourth adhesive deposit on a second surface of the at least one wheel support arch portion, such that upon folding the second sheath panel along the second fold line, the second sheath panel adheres to the second surface of at least one wheel support arch portion by the fourth adhesive deposit.

Advantageously, first sheath panel defines at least one cutout window. Advantageously, the second sheath panel defines at least one cutout window. Advantageously, the blank includes a third panel joined to the first sheath panel along a third fold line. Advantageously, the blank includes a fourth panel joined to the third panel along a fourth fold line. Advantageously, third panel includes a third indentation therein in an edge thereof that registers with the first and second indentations. Advantageously, the blank includes a fourth panel joined to the third panel along a fourth fold line.

In accordance with the invention, a blank for a wheel display device includes a wheel panel. The wheel panel has an inner wheel hub portion, a wheel releasably secured to and circumscribing the inner wheel hub portion, a removeable tab portion releasably secured to the wheel portion, and at least one wheel support arch portion releasably connected to the wheel portion and to the tab portion. A first sheath panel is connected to the wheel panel and joined to the at least one wheel support arch portion along a first fold line with the wheel portion being folded over onto the first sheath panel. A second sheath panel is joined to the first sheath panel along a second fold line with the second sheath panel being folded over onto the first sheath panel so as to capture the wheel panel therebetween. The first sheath panel includes a first indentation therein in an edge thereof adjacent to the tab portion and the second sheath panel includes a second indentation that registers with the first indentation when the sheath panel is folded over onto the first sheath panel so as to permit access to the wheel portion when the tab portion is removed such as to permit the wheel portion to be released from the inner wheel hub portion and at least one wheel support arch portion and to rotate about the inner wheel hub portion.

Advantageously, first sheath panel defines at least one cutout window. Advantageously, the second sheath panel defines at least one cutout window. Advantageously, the blank includes a third panel joined to the first sheath panel along a third fold line. Advantageously, third panel includes a third indentation therein in an edge thereof that registers with the first and second indentations. Advantageously, the blank includes a fourth panel joined to the third panel along a fourth fold line.

### BRIEF DESCRIPTION OF THE DRAWINGS

Exemplary embodiments of the invention will now be described by way of example only with reference to the accompanying drawings in which:

FIG. 1 is top plan view of an exemplary blank for a wheel display device according to an embodiment of the invention.

FIGS. 2A, 2B, and 2C are a series of top plan views of the assembly of the blank of FIG. 1 to form the wheel display device.

### DESCRIPTION OF EXEMPLARY EMBODIMENTS OF THE INVENTION

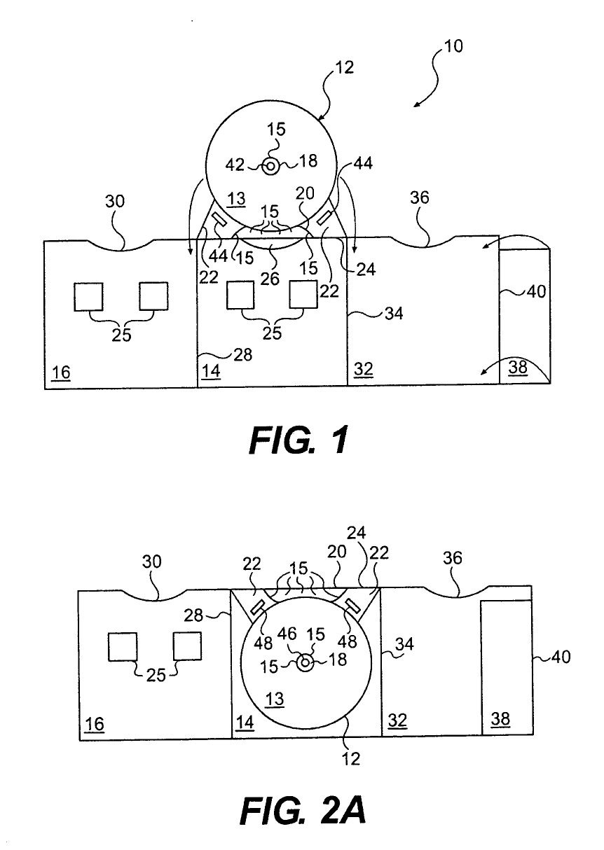

Referring to FIG. 1, there is shown a first preferred embodiment of a blank for a wheel device in accordance with the invention. The planar blank, which is generally denoted 10, includes a wheel panel 12, a first sheath or end panel 14, and a second sheath or end panel 16. It will be understood that the words front and back, left and right, and top and bottom, are merely referenced to the blank, and that the orientation of the blank could be changed from that shown. The blank 10 is preferably made of paper, cardboard, paperboard, or laminates of the same, and is hereinafter referred to as being made of paperboard.

The wheel panel 12, which forms the wheel portion of the wheel device in the assembled device, includes a wheel portion or wheel 13, a concentric inner wheel hub portion 18, a tab portion 20, and at least one wheel support arch, with two wheel support arches, denoted 22, being shown. The wheel 13 is generally circular in shape and surrounds or circumscribes the inner wheel hub portion 18. Wheel portion 13 is releasably secured to the inner wheel hub portion 18 by small connecting elements or microconnectors 15 preferably formed by microperforations, i.e., a series of tiny cuts or holes made in the paperboard so that a small connector element or microconnector made of the remaining paperboard is formed between any two cuts. These microconnectors 15 releasably secure one adjacent section of the blank 10 with another adjacent section of the blank 10 as discussed in more detail below.

The tab portion 20 is similarly releasably secured by microconnectors 15 or the like to the wheel portion 13 and wheel support arch portions 22 so that the wheel panel 12 can be folded over as described in more detail below using machine folding, and can thereafter be released from tab portion 20 and support arch portions 22. In this regard, the wheel support arch portions 22 are releasably secured to the wheel 13 by similar wheel panel microconnectors 15. The microperforations described above can be formed, for example, by die cutting. It will be understood that the various portions described above can be interconnected in other ways so long as the holding forces enable folding of the wheel panel 12 while permitting the various portions to be easily separated.

The first sheath panel 14 is joined to the wheel panel 12 at the wheel support arch portions 22 along a first separation or fold line 24. In the illustrated embodiment, the first sheath panel 14 includes at least one cutout or window, with two such windows, denoted 25, being shown. A dish-shaped opening 26 having a curved lower edge is defined between the first sheath panel 14 and the tab portion 20.

The second sheath panel 16 is joined to the first sheath panel 14 along a second separation or fold line 28. The second sheath panel 16 includes a curved indentation or recess 30 having a curvature congruent with that of the curved portion of opening 26. In this embodiment, the second sheath panel 16 also includes a pair of cutout windows 25. The cutout windows 25 are of a shape that corresponds to the shape of information contained on the wheel 13 that is to be viewed through the windows, or that appropriately reveals such information, as will be further described below. It is noted that each fold line 24 and 38 comprises a fold line or line of weakness, with each line forming a foldable hinge.

In the embodiment illustrated, a third panel 32 is joined to the first sheath panel 14 along a third separation or fold line 34. This third panel 32 defines a curved indentation or recess 36 that is similar to indentation or recess 30 and assists in providing access to the wheel 13 when the blank 10 is assembled. Further, in this particular implementation, a fourth panel 38 is joined to the third panel 32 along a fourth separation or fold line 40.

In a specific, non-limiting example, the blank 10 is approximately 26 13/32 inches in length at its longest and 13 13/32 inches in height at its widest point, the first and third panels 14, 32 are both approximately 7½ inches long and 7½ inches wide, the second panel 16 is approximately 7 13/32 inches long and 7/2 inches wide, the fourth panel 38 is approximately 4 inches long and 6¾ inches wide, the wheel 13 has a diameter of approximately 6 inches, and the inner wheel hub portion 18 has a diameter of approximately 11/16 inches.

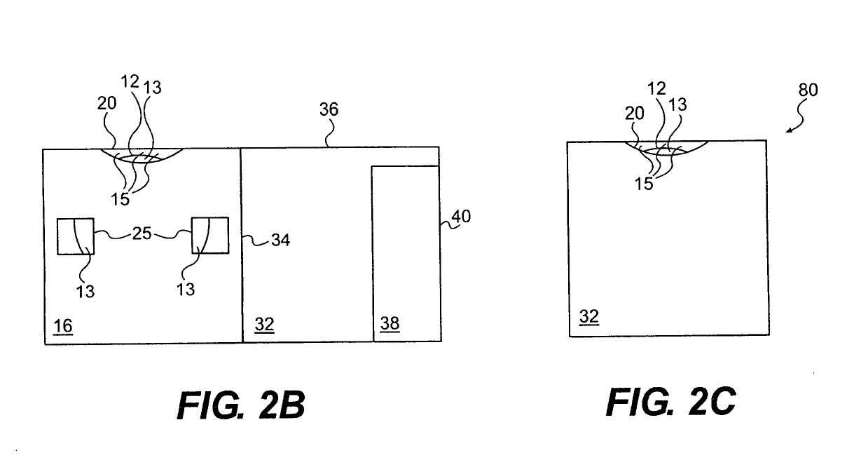

Referring now to FIGS. 2A, 2B, and 2C as well as FIG. 1, the steps used in assembling the blank 10 into a wheel device, denoted 80, in FIG. 2C, are illustrated. The steps for assembling the wheel device 80, of course, include providing a planar blank 10 as shown in FIG. 1 and described above. Next, as is also shown in FIG. 1, adhesive deposits 42 are placed on the front surface of the inner wheel hub portion 18 and further adhesive deposits 44 are placed on the front surfaces of the wheel support arch portions 22.

In an ensuing step, the wheel panel 12 is folded along the first fold line 24, such that the front surface of the inner wheel hub portion 18 and of the wheel support arch portion 22 are caused to adhere to the first sheath panel 14, as illustrated in FIG. 2A, by virtue of the adhesive deposits 42 and 44.

Next, an adhesive deposit 46 is placed on the exposed (formerly rear) surface of the inner wheel hub portion 18 and adhesive deposits 48 are placed on the exposed surfaces of the wheel support arch portion 22.

In a subsequent step illustrated in FIGS. 2A and 2B, the second sheath panel 16 is folded along the second fold line 28 such that the second sheath panel 16 is caused to adhere to the inner wheel hub portion 18 and the wheel support arch portion 22 by virtue of the adhesive deposits 46 and 48. At this point, a unit is formed wherein wheel 13 is captured between sheath panels 14 and 16 and is releasable therefrom so as to rotate about hub portion 18 as described below. As shown in FIG. 2B, portions of wheel 13 are revealed by, i.e., viewable through, windows 25.

As indicated above, in the illustrated embodiment, the blank 10 includes additional panels 32 and 38, each of which is folded along a respective one of fold lines 34 and 40. The folded combination is then folded onto one of the first or second sheath panels 14 and 16. Panels 32 and 38 preferably include information, e.g., advertising information, that completes or compliments that carried by sheath panels 14 and 16 and by wheel 13.

In use, in a preferred embodiment, in order to enable the wheel device 80 of FIG. 2C to function as intended, a user removes the tab portion 20 that is releasably secured to the wheel 13 by the microconnectors 15. To this end, this tab portion 20 is advantageously provided with an instruction such as “Remove This Piece.” With tab portion 20 removed, the user can then access the wheel 13. More specifically, with tab portion 20 removed, a small peripheral portion of wheel 13 is exposed, i.e., extends beyond the sheath panels 14 and 16, into an open region created by opening 26 and indentations 30 and 36, which are all in alignment.

This arrangement enables the exposed portion of the wheel 13 to be gripped by a user and ultimately rotated. To this end, the exposed portion of the wheel is advantageously provided with an instruction to the user such as “Turn Here.” Because the wheel 13 is mounted so as to be rotatable about the inner wheel hub portion 18, an initial rotational force on the wheel 13 will result in breaking of the weak connections provided by the microconnectors 15 that secure the wheel 13 to the hub portion 18 and the wheel support arch portion 22. When this happens, the wheel 13 is free to rotate. The hub portion 18 and wheel support arch portion 22 provide support for the wheel 13 and enable rotation thereof about the hub portion 18, but do not permit other movement of the wheel 13, i.e., limit its movement to rotation. It will be understood that the connections provided by microconnectors 15 are readily broken, and that once this is done, the wheel 13 is easily rotated by the user.

It will be appreciated that the wheel 13 can carry information, such as advertising copy, photographs, or any printed material, in selected areas on one or both sides of the wheel 13. In this embodiment, the first and second sheath panels 14 and 16 include cutouts or windows 25 that reveal different information carried on the wheel 13 as the wheel 13 is rotated about the inner wheel hub portion 18. It will be, of course, understood that a single cutout or window can be used in place of the two windows 25 and that, on the other hand, more than two window can also be used.

It will also be apparent that third and fourth panels 32, 38, are advantageous but optional. They are advantageous because, inter alia, they can carry further information that relates to that appearing on sheath panels 14 and 16 and on wheel 13.

Although the invention has been described above in relation to exemplary embodiments thereof, it will be understood by those skilled in the art that variations and modifications can be effected in these exemplary embodiments without departing from the scope and spirit of the invention.

What is claimed is:

1. A planar blank for making a rotating wheel display device, the blank comprising:
a wheel panel including:
an inner wheel hub portion,
a wheel portion releasably secured to and circumscribing said inner wheel hub portion,
a removeable tab portion releasably secured to said wheel portion, and
at least one wheel support arch portion releasably connected to said wheel portion and to said tab portion;
a first sheath panel connected to said wheel panel and joined to said at least one wheel support arch portion along a first fold line so as to permit said wheel portion to be folded over onto said first sheath panel; and
a second sheath panel joined to said first sheath panel along a second fold line so as to permit said second sheath panel to be folded over onto said first sheath panel so as to capture said wheel panel therebetween;
wherein said first sheath panel including a first indentation therein in an edge thereof adjacent to said tab portion and said second sheath panel including a second indentation that registers with the first indentation when said second sheath panel is folded over onto said first sheath panel so as to permit access to said wheel portion when said tab portion is removed such as to permit said wheel portion to be released from said inner wheel hub portion and said at least one wheel support arch portion and to rotate about said inner wheel hub portion.

2. The blank of claim 1, wherein said first sheath panel defines at least one cutout window.

3. The blank of claim 1, wherein said second sheath panel defines at least one cutout window.

4. The blank of claim 1, further comprising a third panel joined to said first sheath panel along a third fold line.

5. The blank of claim 4, wherein said third panel including a third indentation therein in an edge thereof that registers with the first and second indentations.

6. The blank of claim 4, further comprising a fourth panel joined to said third panel along a fourth fold line.

7. A method for assembling a wheel display device from a planar blank, comprising the steps of:
providing the planar blank, the blank including
a wheel panel, said wheel panel having
an inner wheel hub portion,
a wheel portion releasably secured to and circumscribing said inner wheel hub portion,
a removable tab portion releasably secured to said wheel portion, and
at least one wheel support arch portion releasably connected to said wheel portion and secured to said tab portion,
a first sheath panel connected to said wheel panel and joined to at least one wheel support arch along a first fold line so as to permit said wheel portion to be folded over onto said first sheath panel, and
a second sheath panel joined to said first sheath panel along a second fold line so as to permit said second sheath panel to be folded over onto said first sheath panel so as to capture said wheel panel therebetween,
placing a first adhesive deposit on a first surface of said inner wheel hub portion;
folding said wheel panel along said first fold line over onto said first sheath panel, such that the first surface of said inner wheel hub portion adheres to said first sheath panel by the first adhesive deposit;
placing a second adhesive deposit on a second surface of said inner wheel hub portion; and
folding said second sheath panel along said second fold line, such that said second sheath panel adheres to the second surface of said inner wheel hub portion by the second adhesive deposit;
wherein said first sheath panel including a first indentation therein in an edge thereof adjacent to said tab portion and said second sheath panel including a second indentation that registers with the first indentation when said second sheath panel is folded over onto said first sheath panel so as to permit access to said wheel portion when said tab portion is removed such as to permit said wheel portion to be released from said inner wheel hub portion and said at least one wheel support arch portion and to rotate about said inner wheel hub portion.

8. The method of claim 7, prior to the step of folding said wheel panel along said first fold line, further comprising the step of:
placing a third adhesive deposit on a first surface of said at least one wheel support arch portion, such that upon folding said wheel panel along said first fold line, the first surface of said at least one wheel support arch portion adheres to said first sheath panel by the third adhesive deposit.

9. The method of claim 8, prior to the step of folding said second sheath panel along said second fold line, further comprising the step of:
placing a fourth adhesive deposit on a second surface of said at least one wheel support arch portion, such that upon folding said second sheath panel along said second fold line, said second sheath panel adheres to the second surface of said at least one wheel support arch portion by the fourth adhesive deposit.

10. The method of claim 7, wherein said first sheath panel defines at least one cutout window.

11. The method of claim 7, wherein said second sheath panel defines at least one cutout window.

12. The method of claim 7, wherein the blank further comprises a third panel joined to said first sheath panel along a third fold line.

13. The method of claim 12, wherein the blank further comprises a fourth panel joined to said third panel along a fourth fold line.

14. A wheel display device, comprising:
a wheel panel, said wheel panel including
an inner wheel hub portion,
a wheel portion releasably secured to and circumscribing said inner wheel hub portion,
a removable tab portion releasably secured to said wheel portion, and
at least one wheel support arch portion releasably connected to said wheel portion and to said tab portion;
a first sheath panel connected to said wheel panel and joined to said at least one wheel support arch portion along a first fold line, said wheel portion being folded over onto said first sheath panel; and
a second sheath panel joined to said first sheath panel along a second fold line, said second sheath panel being folded over onto said first sheath panel so as to capture said wheel panel therebetween;
wherein said first sheath panel including a first indentation therein in an edge thereof adjacent to said tab portion and said second sheath panel including a second indentation that registers with the first indentation to permit access to said wheel portion when said tab portion is removed such as to permit said wheel portion to be released from said inner wheel hub portion and said at least one wheel support arch portion and to rotate about said inner wheel hub portion.

15. The display device of claim 14, wherein said first sheath panel defines at least one cutout window.

16. The display device of claim 14, wherein said second sheath panel defines at least one cutout window.

17. The display device of claim 14, further comprising a third panel joined to said first sheath panel along a third fold line.

18. The display device of claim 17, wherein said third panel defines a third indentation therein in an edge thereof that registers with the first and second indentations.

19. The display device of claim 17, further comprising a fourth panel joined to said third panel along a fourth fold line.
